(19) United States
(12) Patent Application Publication
(10) Pub. No.: US 2006/0209198 A1
(43) Pub. Date: Sep. 21, 2006

(54) Image capturing apparatus

(75) Inventors: Ryuichi Kitaoka, Sakai-shi (JP); Hiroaki Kubo, Muko-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/237,206

(22) Filed: Sep. 28, 2005

(30) Foreign Application Priority Data
Mar. 18, 2005 (JP) JP2005-079386

(51) Int. Cl. H04N 5/217

(52) U.S. Cl. 348/241

(57) ABSTRACT

Position information of a defect in a charge transfer line in an image capturing sensor, which causes a V-line blemish in an image is stored in a blemish information memory. A normal transfer is performed on signal charges in a defective portion in the signal charges corresponding to all of pixels of the image capturing sensor, and signal charges that are not related to the defective portion are transferred at high speed and discharged, thereby reading signal charges for detecting the level of a V-line blemish.

This application is based on application No. 2005-079386 filed in Japan, the contents of which are hereby incorporated by reference.

### BACKGROUND OF THE INVENTION

1. Field of the Invention

The present invention relates to an image capturing apparatus.

2. Description of the Background Art

In a CCD image capturing device for use in a digital camera, as the size is being reduced and the number of pixels is increasing, a pixel defect tends to increase.

A technique for dealing with the pixel defect by storing address data of a pixel defect and specifying the position of the pixel defect has been disclosed (for example, Japanese Patent Application Laid-Open No. 7-162757 (1995)).

A defect in the CCD image capturing device also occurs in a vertical transfer line for transferring signal charges and, as a result, a line blemish (V-line blemish) of high luminance occurs in a captured image. Deterioration in the picture quality caused by the V-line blemish is much larger than that caused by a simple pixel defect. Consequently, it is necessary to certainly correct a V-line blemish when an image is generated.

There is a proposed technique of correcting a V-line blemish by performing a process (interpolating process) on a V-line blemish determined to be conspicuous in a captured image by comparing pixels in an area where the V-line blemish occurs with the peripheral pixels. In the process, the pixels in the area are replaced with an average value of the peripheral four pixels of the same color (for example, Japanese Patent Application Laid-Open No. 2004-23683).

In the technique proposed in Japanese Patent Application Laid-Open No. 2004-23683, the picture quality of a captured image deteriorates due to the interpolating process. To assure high quality, it is necessary to obtain an adapted correction amount at the time of capturing an image. Since an occurrence amount and level of the V-line blemish have high dependence on temperature, usually, the amount and level of a V-line blemish are detected immediately after image capturing and a correction amount is determined.

However, long time is required to detect the amount and level of a V-line blemish, and it disturbs the following various operations such as image capturing operation.

### SUMMARY OF THE INVENTION

The present invention is directed to an image capturing apparatus.

According to the present invention, the image capturing apparatus comprises: an image capturing part which has a CCD including a charge transfer line and captures an image of a subject; a storing part which stores position information of a defect in the charge transfer line, which causes a line blemish in the image of a subject; a reading part which reads signal charges for detecting a level of the line blemish by performing a normal transfer on signal charges corresponding to a position of the defect in signal charges corresponding to all of the pixels in the CCD and performing a high-speed transfer on signal charges which do not correspond to the position of the defect in the charge transfer line; and a correcting part which corrects the line blemish on the basis of the signal charges for detecting a level of the line blemish read by the reading part.

Since the time required to read signal charges unnecessary for detecting the level of a V-line blemish can be saved, the level of a V-line blemish can be detected at high speed.

The present invention is also directed to an image capturing method in an image capturing apparatus comprising an image capturing part which has a CCD including a charge transfer line and captures an image of a subject.

Therefore, an object of the present invention is to provide a technique capable of detecting the level of a V-line blemish at high speed.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1C are diagrams showing the appearance configuration of an image capturing apparatus according to a first preferred embodiment of the present invention;

FIG. 2 is a diagram showing finctional blocks of the image capturing apparatus according to the first preferred embodiment of the present invention;

FIG. 3 is a diagram showing the configuration of an image capturing sensor;

FIG. 4 is a diagram illustrating a captured image in which a V-line blemish occurs;

FIG. 5 is a diagram for explaining the principle of detection of a V-line blemish;

FIG. 6 is a diagram for explaining the principle of detection of a V-line blemish;

FIGS. 7A to 7C are diagrams for explaining temperature dependence of a V-line blemish of the image capturing sensor;

FIG. 8 is a diagram for explaining correction of a V-line blemish by using an offset;

FIG. 9 is a diagram for explaining correction of a V-line blemish by using an offset;

FIG. 10 is a diagram for explaining correction of a V-line blemish by using an offset;

FIG. 11 is a diagram for explaining correction of a V-line blemish by pixel interpolation;

FIG. 12 is a diagram for explaining high-speed reading of signal charges for detecting the level of a V-line blemish;

FIG. 13 is a diagram for explaining high-speed reading of signal charges for detecting the level of a V-line blemish;

FIG. 14 is a timing chart for explaining high-speed transfer;

FIG. 15 is a timing chart for explaining high-speed transfer;

FIG. 16 is a flowchart showing the flow of an image capturing operation;

FIG. 17 is a diagram showing the configuration of the image capturing sensor;

FIG. 18 is diagram illustrating a captured image in which a V line blemish occurs;

FIG. 19 is a diagram showing blemish level ratios in temperatures;

FIG. 20 is a flowchart showing an operation flow of registering the address of a defect and a blemish level ratio;

FIG. 21 is a flowchart showing the image capturing operation flow; and

FIG. 22 is a flowchart showing the image capturing operation flow.

### DESCRIPTION OF THE PREFERRED EMBODIMENTS

Preferred embodiments of the present invention will be described with reference to the drawings.

First Preferred Embodiment

Configuration of Main Parts of Image Capturing Apparatus

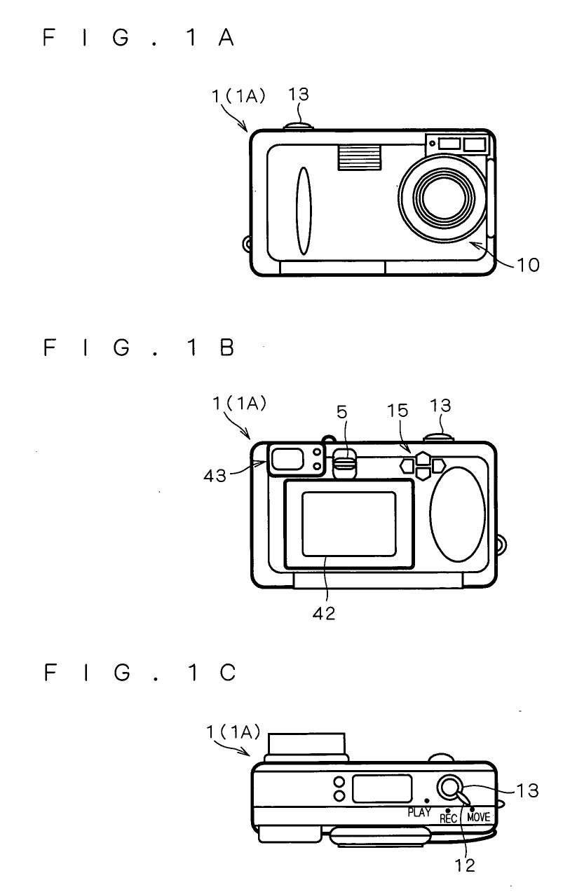

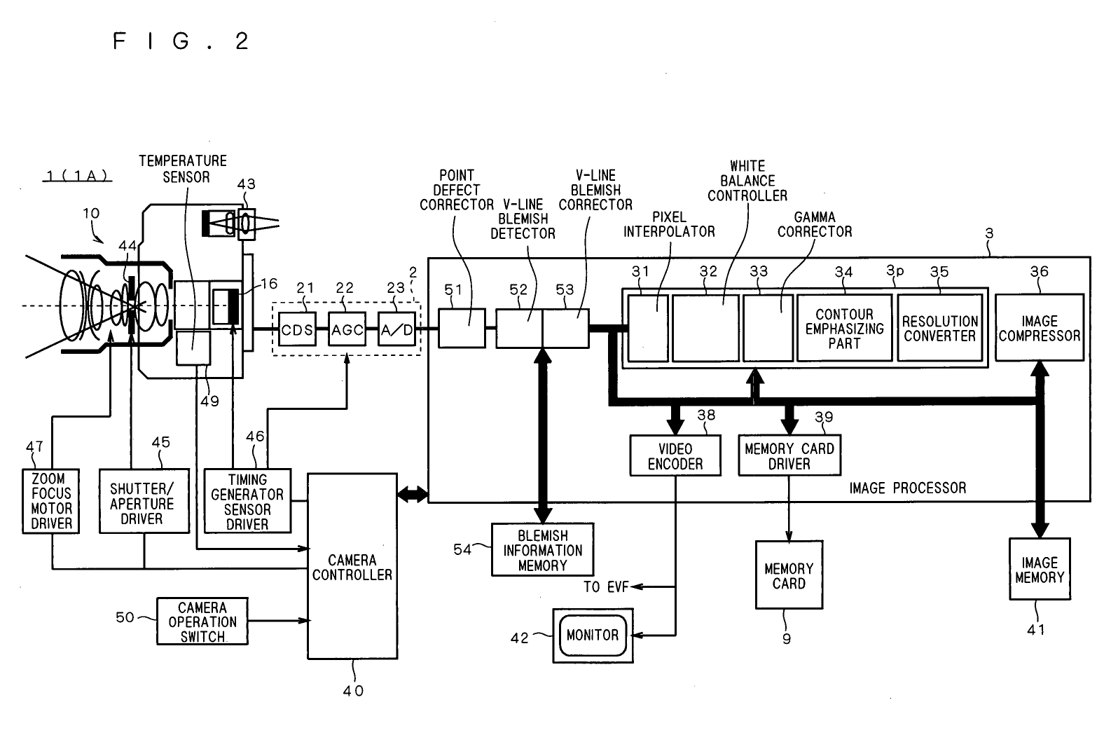

FIGS. 1A to 1C are a front view, a rear view, and a top view showing the configuration of a main part of an image capturing apparatus 1 according to a first preferred embodiment of the present invention.

The image capturing apparatus 1 is constructed as a digital camera and has a taking lens 10.

The image capturing apparatus 1 has, on its top face, a mode changing switch 12 and a shutter release button 13.

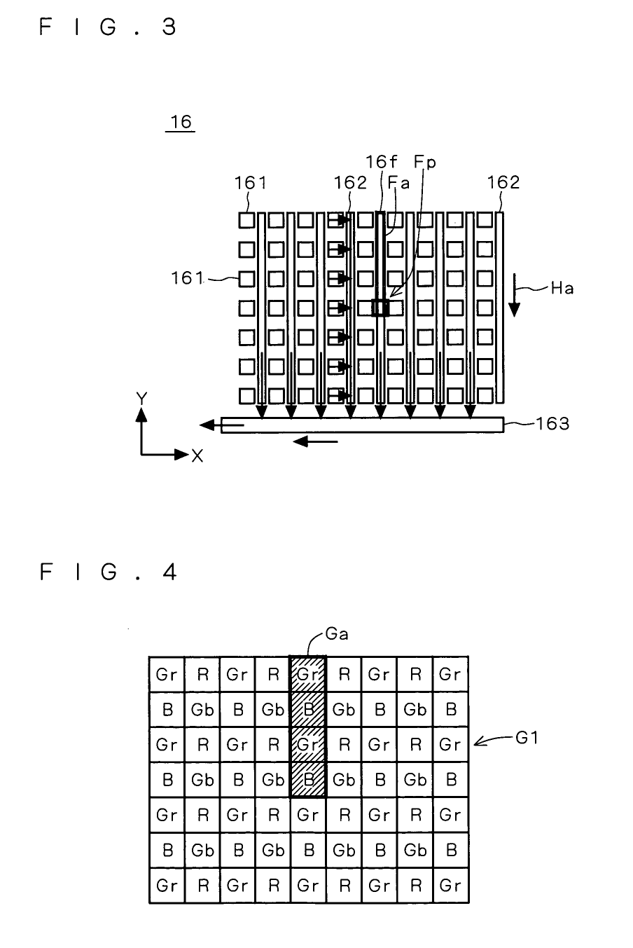

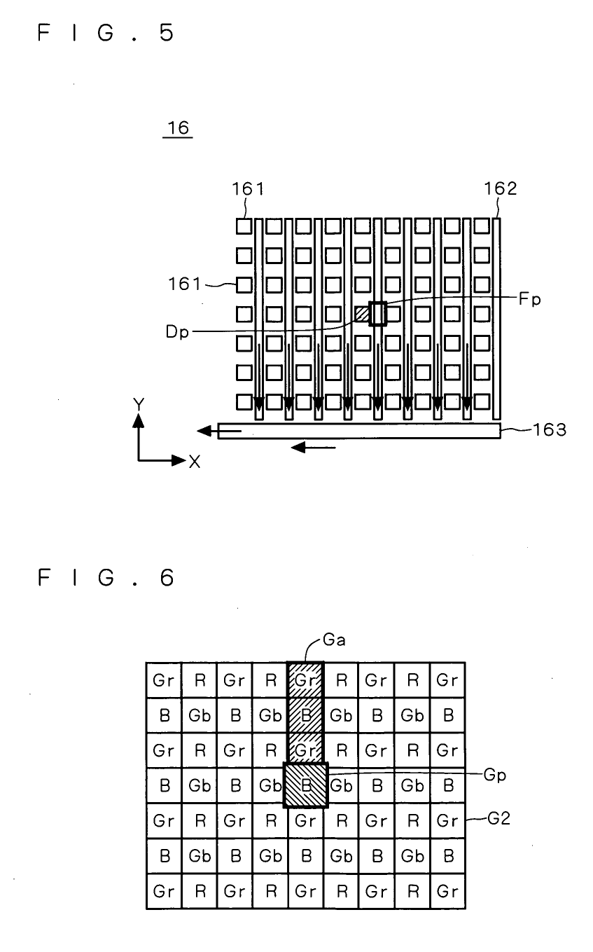

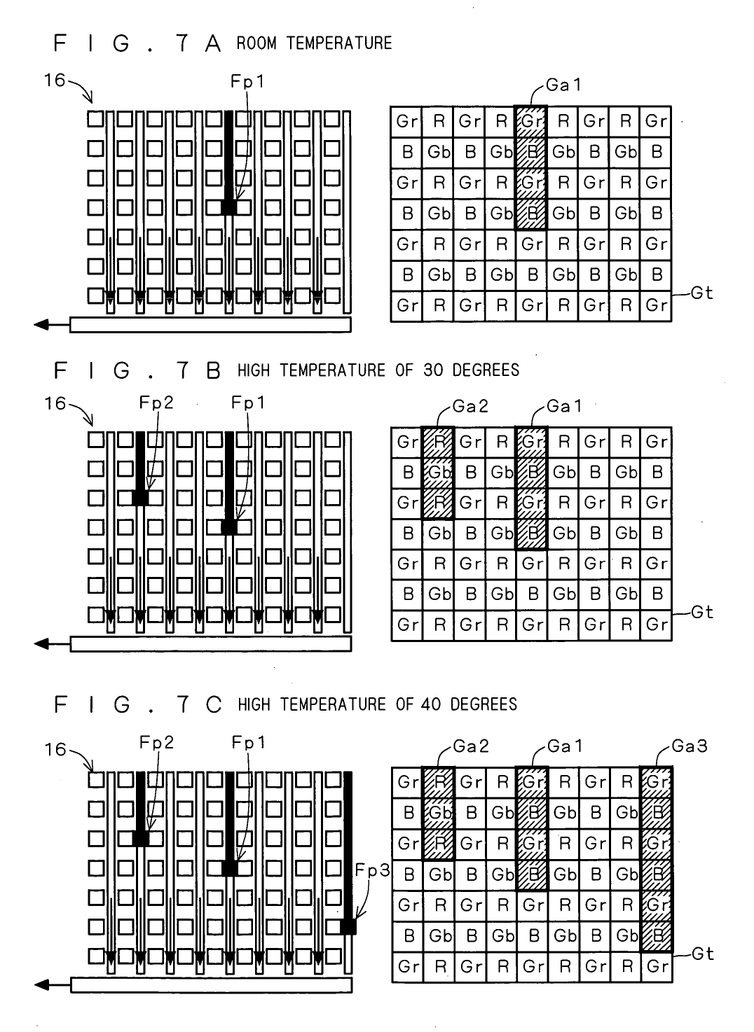

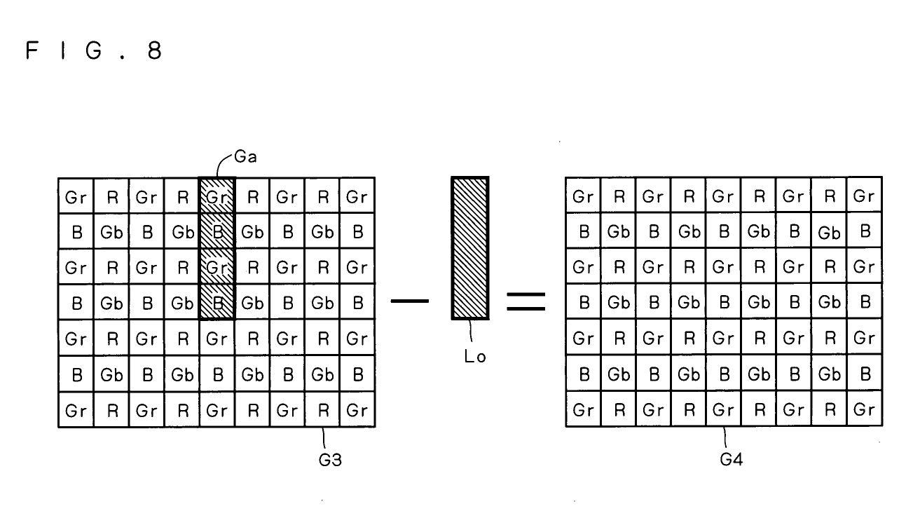

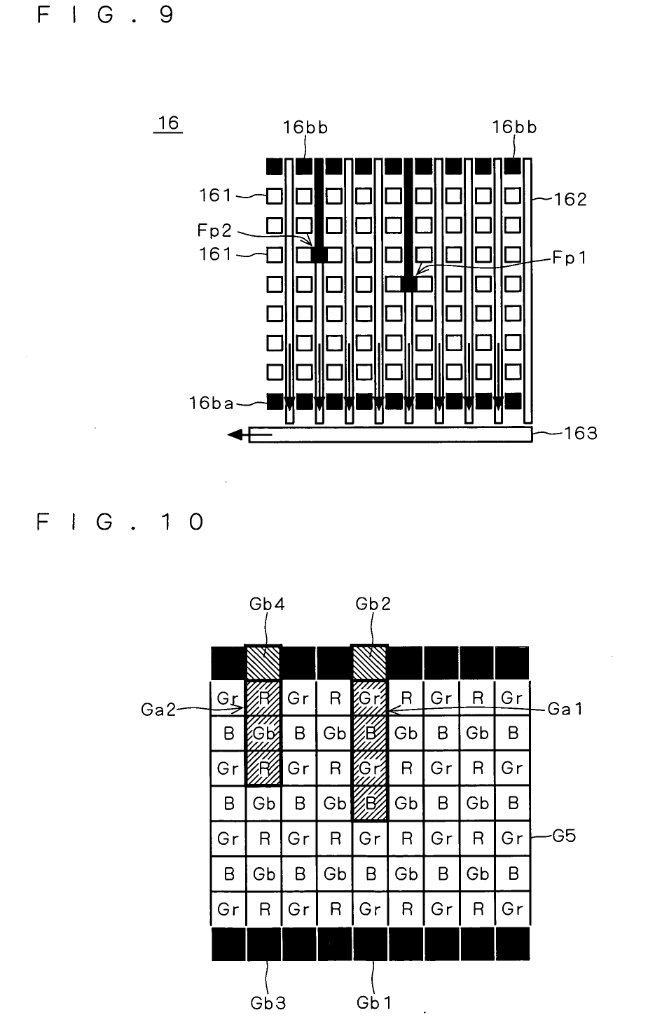

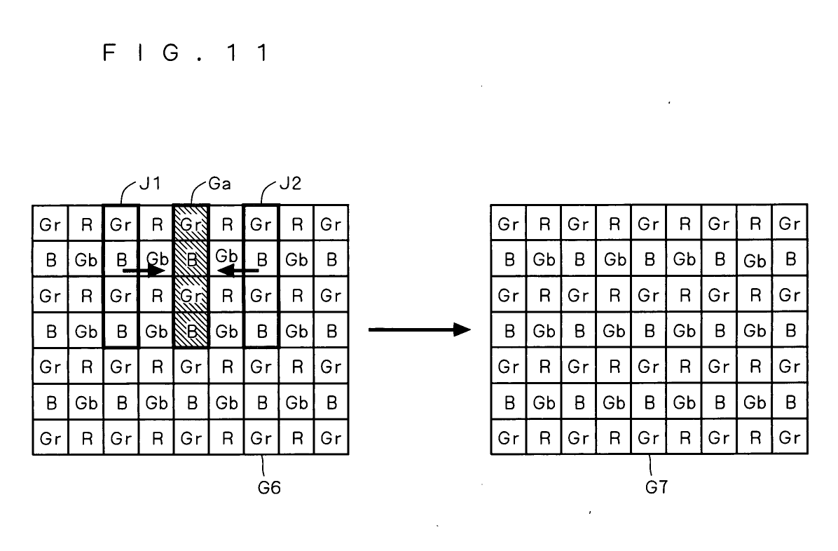

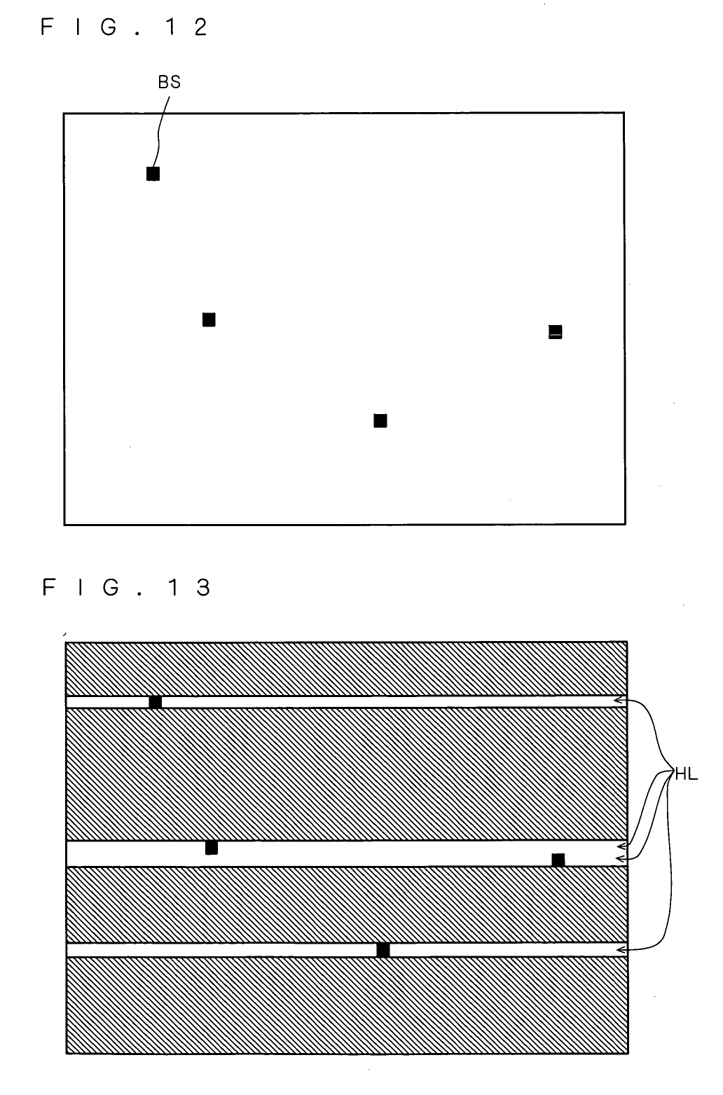

The mode changing switch 12 is a switch for switching among a still picture capturing mode (REC mode) of photographing a subject and recording a still picture of the subject, a moving picture mode (MOVE mode) of capturing a moving picture, and a play mode (PLAY mode) of reproducing a picture recorded on a memory card 9 (refer to FIG. 2).

The shutter release button 13 is a two-level switch capable of detecting a half-press state (S1 on-state) and a depressed state (S2 on-state). When the shutter release button 13 is half-pressed in the still picture capturing mode, a zoom focus motor driver 47 (refer to FIG. 2) is driven and an operation of moving the taking lens 10 to the focus position is performed. On the other hand, when the shutter release button 13 is depressed in the still picture capturing mode, an image capturing operation, specifically, an operation of capturing an image to be recorded (main image capturing) is performed.

On the rear face of the image capturing apparatus 1, an LCD (Liquid Crystal Display) monitor 42 for displaying a captured image or the like, an electronic view finder (EVF) 43, a frame advance/zoom switch 15, and a power source switch 5 are provided.

The frame advance/zoom switch 15 is constructed by four buttons and is provided for instructing frame-advance of a recorded image in the play mode and zooming at the time of photographing. By operating the frame advance/zoom switch 15, the zoom focus motor driver 47 is driven and the focal distance of the taking lens 10 can be changed.

The power source switch 5 is operated in the vertical direction to switch between a state where the image capturing apparatus 1 is started (power-on state) and a state where the image capturing apparatus 1 is not started (power-off state).

Functional Configuration of Image Capturing Apparatus

FIG. 2 is a diagram showing functional blocks of the image capturing apparatus 1.

The image capturing apparatus 1 has an image capturing sensor 16, a signal processor 2 connected to the image capturing sensor 16 so as to be able to transmit data, an image processor 3 connected to the image processor 2, and a camera controller 40 connected to the image processor 3.

The image capturing sensor 16 is constructed as an area sensor (CCD image capturing device, also simply referred to as “CCD”) in which primary color transmission filters of R (red), G (green), and B (blue) as a plurality of kinds of color components are arranged in a checker state on a pixel unit basis (Bayer matrix). The image capturing sensor 16 is of an all-pixel reading type. The temperature of the image capturing sensor 16 can be detected by a temperature sensor 49 which measures temperature in the chassis of the image capturing apparatus 1.

After completion of storage of charges by exposure in the image capturing sensor 16, photoelectrically converted signal charges are shifted to a vertical/horizontal transfer path in the image capturing sensor 16 and output as an image signal via a buffer. That is, the image capturing sensor 16 functions as image capturing means of obtaining an image signal (image) of a subject.

The signal processor 2 has a CDS 21, an AGC 22, and an A/D converter 23 and functions as a so-called analog front end.

An analog image signal output from the image capturing sensor 16 is subjected to sampling and noise elimination in the CDS 21. After that, the resultant signal is multiplied by an analog gain corresponding to image capture sensitivity in the AGC 22 for making sensitivity correction.

The A/D converter 23 is constructed as, for example, a 14-bit converter and converts an analog signal normalized in the AGC 22 to a digital signal. A digitally-converted image signal is subjected to predetermined image processes in the image processor 3 and an image file is generated.

The image processor 3 has a point defect corrector 51, a V-line blemish detector 52, and a V-line blemish corrector 53. The image processor 3 has a digital processor 3p, an image compressor 36, a video encoder 38, and a memory card driver 39.

With respect to the image data input to the image processor 3, first, pixel data in which a defect exists is replaced with correction data on the basis of a point defect address pre-stored in the point defect corrector 51.

The V-line blemish detector 52 detects the level (pixel value) of a line blemish (also referred to as “linear blemish” and, hereinafter, referred to as “V-line blemish”) which occurs in an image due to a defect position in a vertical transfer line (vertical CCD) in the image capturing sensor 16. The detected level of the V-line blemish is stored in a blemish information memory 54.

Image data to be recorded/reproduced in the image data output from the point defect corrector 51 is subjected to V-line blemish correction in the V-line blemish corrector 53 in accordance with the level of the V-line blemish (blemish level) detected by the V-line blemish detector 52 (which will be described in detail later). The image data whose V-line blemish is corrected is input to the digital processor 3p. Image data for detecting a blemish level is provided for detecting a blemish level in the V-line blemish detector 52.

At a predetermined timing before shipment from a factory, the address of a V-line blemish (that is, the address of a defect in the vertical CCD) is detected by the V-line blemish detector 52 and stored in the blemish information memory 54. Since the number of defects which cause a V-line blemish has temperature dependence, addresses of defects are stored by temperature, thereby generating address information by temperature (also referred to as “position information by temperature”).

The digital processor 3p has a pixel interpolator 31, a white balance controller 32, a gamma corrector 33, a contour emphasizing part 34, and a resolution converter 35.

Image data input to the digital processor 3p is written into an image memory 41 synchronously with reading of the image capturing sensor 16. After that, image data stored in the image memory 41 is accessed and various processes are performed by the digital processor 3p.

First, each of R, G, and B pixels of the image data in the image memory 41 is independently subjected to gain correction and is subjected to white balance correction made by the white balance controller 32. In the white balance correction, a part which is inherently white in a captured subject is estimated on the basis of brightness, color saturation data, and the like, an average value of each of R, G, and B in the part, the G/R ratio, and the G/B ratio are obtained. On the basis of the information, correction gains of R and B are determined.

Each of the R, G, and B pixels in the image data subjected to the white balance correction is masked with a filter pattern in the pixel interpolator 31. After that, with respect to the G pixel having a pixel value also in a high bandwidth, a spatial change in a pixel value is estimated on the basis of a contrast pattern of 12 pixels around a target pixel, and a pixel value optimum to the pattern of a subject is calculated on the basis of data of four pixels in the periphery and assigned to the target pixel. With respect to the R and B pixels, interpolation is performed on the basis of the pixel values of the same color of eight pixels in the periphery.

The pixel-interpolated image data is subjected to nonlinear transformation, concretely, gamma correction and offset adjustment adapted to each output device by the gamma corrector 33, and the resultant is stored in the image memory 41.

The contour emphasizing part 34 performs an edge emphasizing process of emphasizing a contour by a high-pass filter or the like adapted to image data.

The number of pixels in the image data stored in the image memory 41 is reduced in the vertical and horizontal directions by the resolution converter 35. The resultant image is subjected to a compressing process in the image compressor 36. After that, the compressed image is recorded in the memory card 9 that is set in the memory card driver 39. At the time of image recording, a captured image of designated resolution is recorded.

The resolution converter 35 reduces the number of pixels also at the time of displaying an image to generate a low-resolution image to be displayed on the LCD monitor 42 or EVF 43. At the time of preview, a low-resolution image of 640×240 pixels read from the image memory 41 is encoded to NTSC/PAL image by the video encoder 38. By using the read image as a field image, an image is reproduced on the LCD monitor 42 or EVF 43.

The camera controller 40 has a CPU and a memory and is a part for controlling the components of the image capturing apparatus 1 in a centralized manner. Concretely, the camera controller 40 processes an operation input of the user on a camera operation switch 50 having the mode changing switch 12, shutter release button 13, frame advance/zoom switch 15, power source switch 5, and the like.

The camera controller 40 switches among the still picture capturing mode of photographing a subject and recording image data, moving picture mode, and play mode by an operation on the mode changing switch 12 by the user. In response to an operation on the power source switch 5 by the user, the power is turned on or off.

Further, at the time of reading image data for detecting a V-line blemish from the image capturing sensor 16, the camera controller 40 controls reading of signal charges on the basis of the address of the defect in a vertical CCD stored in the blemish information memory 54. Concrete reading control will be described later.

In the image capturing apparatus 1, at the time of preview display (live view display) of displaying an image of a subject on the LCD monitor 42 in a moving picture mode in a preparation state before main image capturing, an optical aperture of an aperture 44 is fixedly opened by a shutter/aperture driver 45.

As for charge accumulation time (exposure time) of the image capturing sensor 16 corresponding to shutter speed (SS), the camera controller 40 computes exposure control data on the basis of the live view image obtained by the image capturing sensor 16. On the basis of a pre-set program chart and the computed exposure control data, feedback control to a timing generator sensor driver 46 is performed so that exposure time of the image capturing sensor 16 becomes proper.

At the time of main image capturing, on the basis of a pre-set program chart and light amount data measured at the time of live view, the amount of exposure to the image capturing sensor 16 is controlled by the shutter/aperture driver 45 and the timing generator sensor driver 46.

Hereinafter, occurrence of a V-line blemish, detection of a V-line blemish, temperature dependence of a V-line blemish, and correction of a V-line blemish will be described. With respect to detection of a V-line blemish, a conventional V-line blemish detecting method will be also described as a comparative example.

Occurrence of V-line Blemish

FIG. 3 is a diagram showing the configuration of the image capturing sensor 16.

In the image capturing sensor 16, charges photoelectrically converted and accumulated by photodiodes 161 are read by a vertical CCD (hereinafter, also described as “VCCD”) 162 provided for each vertical transfer line, and transferred to a horizontal CCD 163 at the bottom of the image capturing sensor 16 every 1-horizontal period. The charges transferred to the horizontal CCD 163 are read on the basis of a pixel clock, thereby performing reading in the horizontal pixel direction. Lines for transferring charges such as the VCCD 162 and horizontal CCD 163 will be also generically referred to as “charge transfer lines”.

By such operation of the image capturing sensor 16, a two-dimensional image obtained by the photodiodes 161 arranged two-dimensionally is scanned every horizontal line.

In the case where there is a defect in the photodiodes 161, a charge generated by the defect is added to the signal charges, so that the defect is reproduced as a point defect in a captured image. The point defect is corrected by subtracting a pixel level corresponding to a charge generated due to the defect by the point defect corrector 51.

On the other hand, when a similar defective portion (blemish) Fp exists in part of the vertical transfer line, a charge from a photodiode whose address is the same in the X direction as that of a photodiode from which a charge is read via the defective portion Fp is output from the image capturing sensor 16 via a vertical CCD 16f including the defective portion Fp. Consequently, the charge generated by the defect is added to a signal charge group Fa transferred from upstream in a charge transfer direction Ha to the defective portion Fp. As shown in FIG. 4, the defective portion is reproduced as a line blemish (V-line blemish) Ga having high lightness in a captured image G1.

Although the number of factors of deterioration that occurs in a captured image is small in the case of the point defect, the influence on picture quality is very large in the case of the V-line blemish Ga as shown in FIG. 4. Consequently, it is important to detect the V-line blemish Ga. In the following, the detecting method will be described.

V-Line Blemish Detecting Method

FIGS. 5 and 6 are diagrams for explaining the principle of detecting a V-line blemish.

The V-line blemish Ga (FIG. 4) occurs as a lightness line blemish in an image due to the signal charge group Fa read via the defective portion Fp in the vertical CCD 162 shown in FIG. 3 as described above.

Consequently, light is shut out by a shutter, and transfer of charges in the vertical. CCD 162 is stopped for a predetermined period (for example, 200 horizontal periods) as shown in FIG. 5, thereby increasing an amount of charges generated in the defective portion Fp. After that, an image is read. In such a manner, pixel data of a photodiode Dp from which a signal charge is read via the defective portion Fp in the vertical CCD 162 is emphasized and the resultant image can be output from the image capturing sensor 16.

In an image G2 in which the defective portion Fp is emphasized and which is output from the image capturing sensor 16, as shown in FIG. 6, the pixel level of a B pixel Gp corresponding to the position of the photodiode Dp (FIG. 5) from which a charge is read via the defective portion Fp in the V-line blemish Ga is emphasized in direct proportion to the transfer stop period of the vertical CCD 162.

By reading the image G2 and, then, detecting the address of the pixel Gp as a luminance point of high lightness in the image G2, the position (address) of the defective portion corresponding to the lower end of the V-line blemish can be detected.

Such an operation of detecting a V-line blemish is performed, for example, under a plurality of temperature conditions before shipment of an image capturing apparatus from a factory. At the time of shipment from the factory, necessary information is stored as default data.

Temperature Dependence of V-line Blemish

A V-line blemish in the image capturing sensor 16 has temperature dependence and this characteristic will be described below.

FIGS. 7A to 7C are diagrams for explaining the temperature dependence of a V-line blemish in the image capturing sensor 16. FIGS. 7A to 7C show examples of the state of the image capturing sensor 16 and an image Gt output from the image capturing sensor 16 when the temperature around the sensor is room temperature (for example, at 20° C.), high temperature of 30° C., and high temperature of 40° C., respectively.

In the image capturing sensor 16 at the room temperature, as shown in FIG. 7A, a defective portion in the vertical CCD recognized as a blemish is only one portion Fp1, and a V-line blemish that occurs in the image Gt output from the image capturing sensor 16 is only one V-line blemish Ga1.

In the image capturing sensor 16 at high temperature of 30° C., the number of V-line blemishes that become obvious increases by one as compared with that at room temperature with a dependence on temperature. Specifically, as shown in FIG. 7B, defective portions in the vertical CCD recognized as blemishes become two defective portions Fp1 and Fp2, and there are two V-line blemishes Ga1 and Ga2 in the image Gt output from the image capturing sensor 16.

In the image capturing sensor 16 at high temperature of 40° C., the number of V-line blemishes that become obvious increases by one as compared with that at the high temperature of 30° C. Specifically, as shown in FIG. 7C, defective portions in the vertical CCD recognized as blemishes become three defective portions Fp1 to Fp3, and there are three V-line blemishes Ga1 to Ga3 in the image Gt output from the image capturing sensor 16.

As described above, there is a tendency that the amount of V-line blemishes increases as the temperature of the image capturing sensor 16 rises. In addition, as the temperature rises, the level of a V-line blemish tends to increase. That is, in the image capturing sensor 16, a V-line blemish has dependence on temperature. Consequently, it is preferable to detect a V-line blemish at respective temperatures.

Correction of V-line Blemish

As correction of a V-line blemish, two kinds of correcting methods of (1) correction by using an offset and (2) correction by using pixel interpolation are provided. The two kinds of correcting methods will be described below.

(1) Correction by using Offset

FIG. 8 is a diagram for explaining correction of a V-line blemish by using an offset.

In correction of a V-line blemish by using an offset, first, an offset component Lo caused by the V-line blemish Ga in an image G3 output from the image capturing sensor 16 is detected. By subtracting the offset component (level of the V-line blemish) Lo from the pixel level of the V-line blemish Ga in the image G3, a corrected image G4 obtained by erasing the blemish as image noise is generated.

In such a correcting method using an offset, as described above, on the basis of data of a default V-line blemish stored in the blemish information memory 54 before factory shipment of the image capturing apparatus 1, the blemish level (offset component Lo) is estimated, and the V-line blemish may be corrected. However, when the characteristic of a V-line blemish having high dependence on temperature is considered, it is preferable to obtain an offset amount (correction amount) in a real-time manner at the time of image capturing.

Hitherto, the following two methods of detecting an offset amount have been proposed.

(1-1) First Offset Amount Detecting Method

Detection of an offset amount is realized after completion of exposure and reading of signal charges in main image capturing by a method similar to the method of detecting a V-line blemish before factory shipment described with reference to FIGS. 5 and 6. It is sufficient to detect a level obtained by normalization of reducing a signal charge in the defective portion Fp to 1/200 as the level of a V-line blemish and use the blemish level as an offset amount.

(1-2) Second Offset Amount Detecting Method

The image capturing sensor 16 has optical black parts (hereinafter, “OB parts”) 16ba and 16bb for detecting black level as shown in FIG. 9. With respect to charges read from the OB parts to the vertical CCD 162, the charge from the OB part 16ba at the bottom is transferred first to the horizontal CCD 163 and, after that, the charge from the OB part 16bb at the top is transferred. In the following, detection of the offset amount in the case where the two defective portions Fp1 and Fp2 exist in the vertical CCD 162 will be described.

As shown in FIG. 10, in an image G5 output from the image capturing sensor 16, the pixel level of a pixel Gb2 read from the OB part 16bb at the top and passed through and influenced by the defective portion Fp1 in the vertical CCD 162 is higher than that of a pixel Gb1 which is read from the OB part 16ba at the bottom and does not pass through and is not influenced by the defective portion Fp1 only by the offset amount. Similarly, the pixel level of a pixel Gb4 read from the OB part 16bb at the top and passed through and influenced by the defective portion Fp2 in the vertical CCD 162 is higher than that of a pixel Gb3 which does not pass through the defective portion Fp2 only by the offset amount.

Therefore, the blemish level (offset amount) of the V-line blemish Ga1 shown in FIG. 10 is obtained by subtracting the level of the pixel Gb1 from the level of the pixel Gb2, and the offset amount of the V-line blemish Ga2 is obtained by subtracting the level of the pixel Gb3 from the level of the pixel Gb4.

(2) Correction by Pixel Interpolation

FIG. 11 is a diagram for explaining correction of a V-line blemish by using pixel interpolation.

In correction of a V-line blemish by using pixel interpolation, a process of generating replacement data on the basis of data of a pixel line positioned in the periphery of a V-line blemish and replacing pixel data of the V-line blemish with the replacement data is performed.

For example, in an image G6, pixel lines J2 and J1 of the same color disposed on the right and left sides of the V-line blemish Ga are detected. The pixel data of the V-line blemish Ga is replaced with an average value of the pixel levels of the pixel lines J1 and J2. In such a manner, a corrected image G7 obtained by eliminating the blemish is generated.

In the correcting method using such pixel interpolation, when the position (address) of a V-line blemish is known, it is unnecessary to detect a blemish level. In the interpolating method using pixel interpolation, it is basically unnecessary to consider the temperature characteristic of a V-line blemish.

The precision of the correction of a V-line blemish by pixel interpolation is, however, lower than that of a V-line blemish by using an offset.

Therefore, in order to avoid deterioration in quality of a captured image, correction of a V-line blemish by using an offset is employed. In this case, however, it takes long time to detect an offset amount.

In the image capturing apparatus 1 according to the first preferred embodiment of the present invention, by increasing the speed of reading signal charges from the image capturing sensor 16 at the time of detecting an offset amount while employing, as an assumption, the V-line blemish correction using an offset to maintain the picture quality, time required to detect an offset amount is shortened.

Hereinafter, detection of an offset amount, that is, the level of a V-line blemish immediately after main image capturing of the image capturing apparatus 1 will be described.

Detection of Level of V-line Blemish

In the image capturing apparatus 1, at the time of obtaining image data for detecting the level of a V-line blemish, while basically employing the first offset amount detecting method, the speed of discharging of signal charges in a charge transfer line is increased.

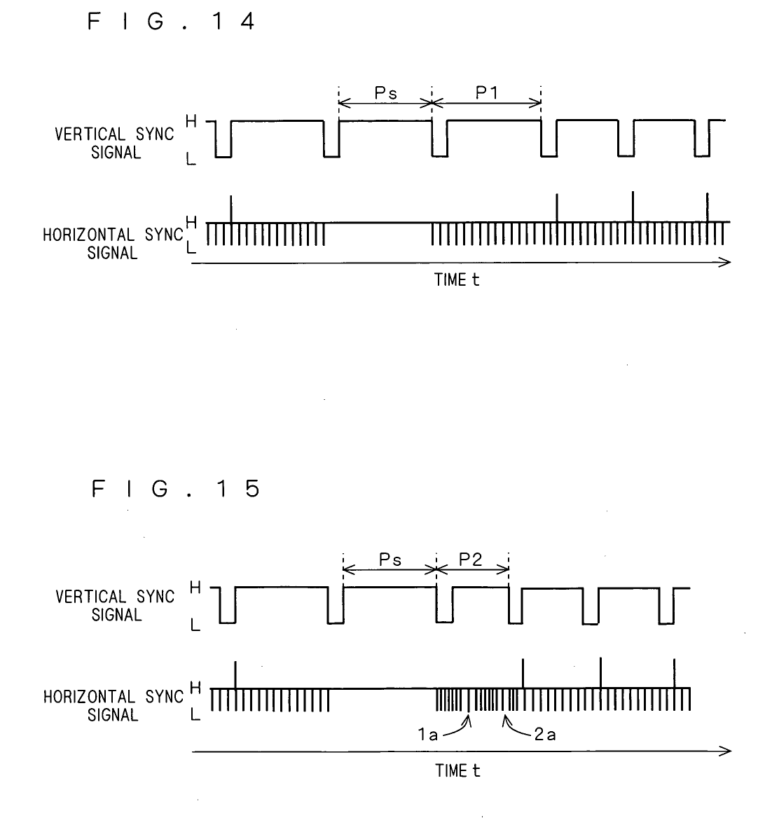

FIGS. 12 and 13 are diagrams for explaining high-speed reading of signal charges for detecting the level of a V-line blemish.

FIG. 12 illustrates addresses of defects in the VCCD 162 stored in the blemish information memory 54. The rectangular frame corresponds to all of addresses of the VCCD 162, and four black rectangular marks BS in the diagram indicate the positions (that is, addresses) of defective portions at a temperature. FIG. 13 illustrates horizontal lines on which normal transfer and high-speed transfer which will be described later are to be performed in all of horizontal lines of the CCD.

The image capturing sensor 16 performs a transfer similar to that in main image capturing (also referred to as “normal transfer”) on signal charges in a horizontal line including a defective portion. The normal transfer in this case is a signal charge transfer performed in such a manner that, after discharging all of signal charges in the HCCD 163, signal charges in one horizontal line are transferred from the VCCD 162 to the HCCD 163. In a state where the transfer of the signal charges from the VCCD 162 to the HCCD 163 is stopped, all of the signal charges in one horizontal line are read from the HCCD 163.

On the other hand, signal charges in a horizontal line including no defective portion are transferred at high speed (also referred to as “high-speed transfer”) relative to the transfer in the main image capturing. The high-speed transfer in this case is a signal charge transfer of time-sequentially transferring signal charges from the VCCD 162 to the HCCD 163 before discharge of the HCCD 163 finishes. Therefore, in the high-speed transfer, an interval (one horizontal period) of transferring signal charges in a horizontal line from the VCCD 162 to the HCCD 163 can be shortened.

Concretely, the address of a defect according to temperature regarding the image capturing sensor 16 detected by the temperature sensor 49 is recognized from the blemish information memory 54. For example, in the case where the positions of defective portions are as shown in FIG. 12, as shown in FIG. 13, the normal transfer is performed on the signal charges in four horizontal lines HL each including the defective portion, and the high-speed transfer is performed on signal charges in the other horizontal lines (hatched portions in the diagram).

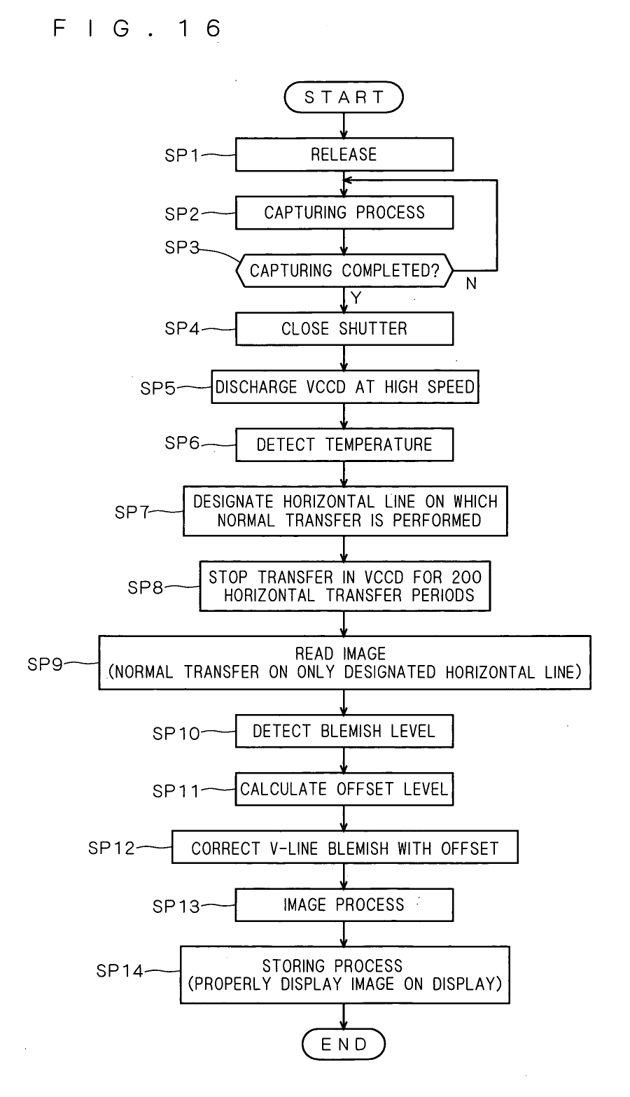

FIGS. 14 and 15 are timing charts for explaining the high-speed transfer. FIG. 14 is a timing chart of a vertical sync signal and a horizontal sync signal in conventional detection of the level of a V-line blemish. FIG. 15 is a timing chart of a vertical sync signal and a horizontal sync signal in detection of the level of a V-line blemish of the image capturing apparatus 1. Although a large number of vertical sync signals are generated in practice, in FIGS. 14 and 15, a small number of vertical sync signals are shown to avoid complication of the diagrams.

In FIGS. 14 and 15, each time the vertical sync signal shifts from the high (H) level to the low (L) level, reading of signal charges of one frame (or one field) starts. Each time the horizontal sync signal shifts from the high (H) level to the low (L) level, signal charges in one horizontal line are transferred from the VCCD 162 to the HCCD 163.

As shown in FIG. 14, conventionally, transfer from the VCCD 162 is stopped only for 200 horizontal periods Ps in a state where the shutter (shutter mechanism) is closed and, after that, the normal transfer is performed on the signal charges in all of horizontal lines in the CCD. In FIG. 14, the signal charge reading period in the detection of the level of a V-line blemish is expressed as a period P1.

On the other hand, as shown in FIG. 15, in the image capturing apparatus 1, transfer from the VCCD 162 is stopped for only 200 horizontal periods Ps in a state where the shutter is closed, and, after that, the normal transfer is performed on only signal charges in at least one horizontal line including a defective portion (corresponding to horizontal sync signals 1a and 2a). The high-speed transfer is performed on signal charges in the other horizontal lines. Specifically, when the signal charges in a horizontal line including no defective portion are transferred from the VCCD 162 to the HCCD 163, the interval in which the horizontal sync signal is at the L level, that is, one horizontal period becomes shorter relative to the normal transfer. As a result, a signal charge reading period P2 in detection of the level of a V-line blemish becomes much shorter than the period P1. Although the difference between the period P2 and the period P1 is not shown large for convenience of the drawing, the period P2 can be a fraction of tens of the period P1 depending on a condition.

A control of driving the image capturing sensor 16 by such vertical and horizontal sync signals is realized by the camera controller 40 and the timing generator sensor driver 46.

Although the signal charge reading speed is increased by shortening one horizontal period in the high-speed transfer in the above preferred embodiment, the one horizontal period in the high-speed transfer can be further shortened by increasing the transfer speed in the VCCD 162.

An image capturing operation in the image capturing apparatus 1 in which the period of detection of the level of a V-line blemish is shortened is performed as follows.

Image Capturing Operation

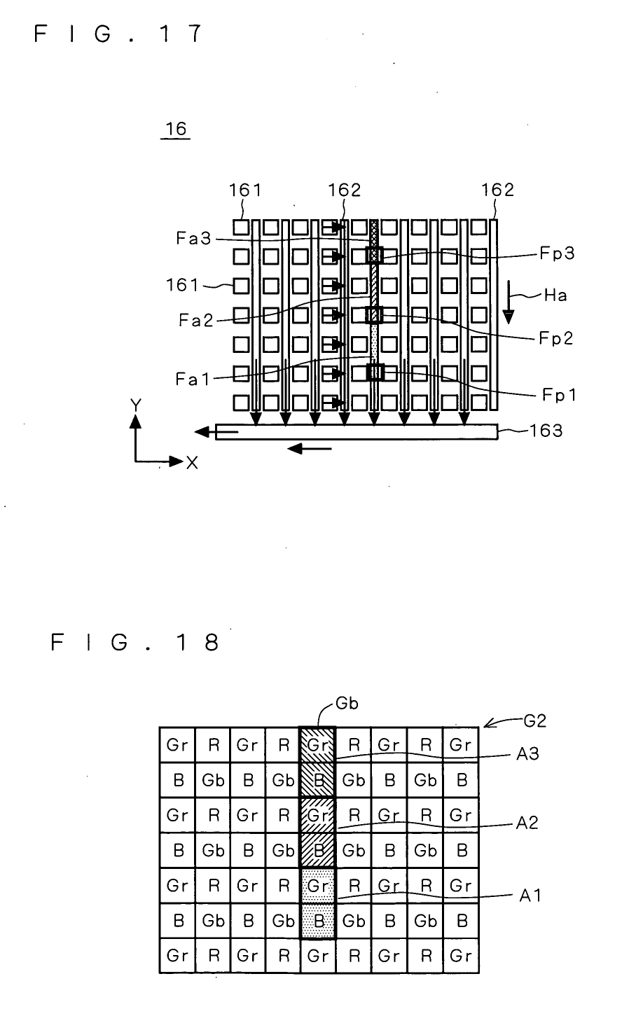

FIG. 16 is a flowchart showing an image capturing operation flow in the image capturing apparatus 1. The operation flow is realized by control of the camera controller 40.

In step SP1, the shutter is released to conduct exposure. Specifically, the shutter release button 13 is depressed by the user (S2 on-state) and an operation of photographing a subject is performed.

In step SP2, a process of capturing pixel data read from the image capturing sensor 16 in step SP1 is executed.

In step SP3, whether the capturing process has completed or not is determined. When the capturing process has completed, the program advances to step SP4. When the capturing process has not completed, the operations in steps SP2 and SP3 are repeated.

In step SP4, the aperture 44 corresponding to a shutter is closed. In the case where the shutter is closed at the time of the capturing process, the state where the shutter is closed is maintained.

In step SP5, high-speed charge reading is executed in the VCCD 162.

In step SP6, the temperature regarding the image capturing sensor 16 is detected by the temperature sensor 49.

In step SP7, a horizontal line including a defective portion in all of the horizontal lines of the CCD is designated as a horizontal line from which signal charges are subjected to the normal transfer. In this case, by referring to the position information (position information by temperature) of defective portions stored in the blemish information memory 54, at least one position of a defect at the temperature detected in step SP6 is recognized. In short, at least one position of a defect according to the temperature is recognized from the position information by temperature. The horizontal line including the defect is designated as a horizontal line from which signal charges are subjected to the normal transfer.

In step SP8, as described above, the transfer in the VCCD 162 is stopped for 200 horizontal transfer periods. Consequently, charges are amplified in the defective portion in the VCCD 162. In practice, in parallel with the process in step SP8, the processes in step SP6 and SP7 are performed.

In step SP9, as described above, reading of image data is executed in such a manner that while the normal transfer is performed only on the signal charges in the horizontal line designated in step SP7, the high-speed transfer is performed on the signal charges in the other horizontal lines.

In step S10, the V-line blemish detector 52 detects the level of the V-line blemish on the basis of the image data read in step SP9.

In step S11, an offset amount (level) according to the level of the V-line blemish detected in step SP10 is calculated.

In step SP12, a V-line blemish offset correction using the offset amount calculated in step SP11 is made on the image data captured in steps SP2 and SP3.

In step SP13, other image processes such as white balance correction and gamma correction are performed on the image data subjected to the offset correction in step SP12.

In step SP14, a storing process of storing the image data subjected to the image process in step SP13 into the memory card 9 is performed and the operation flow is finished. In step SP14, image data is properly output so as to be visible to the LCD monitor 42.

As described above, in the image capturing apparatus 1 according to the first preferred embodiment of the present invention, the position information of a defect in a charge transfer line which causes a V-line blemish in an image is stored in the blemish information memory 54. At the time of reading signal charges for detecting the level of a V-line blemish, the normal transfer is performed on signal charges in a horizontal line including a defective portion in the signal charges corresponding to all of pixels in the CCD. On the other hand, the signal charges in horizontal lines including no defective portion are transferred at high speed and discharged. With such a configuration, the time conventionally required for reading signal charges unnecessary to detect the level of a V-line blemish can be omitted, so that the level of a V-line blemish can be detected at high speed.

By executing the offset using the detected level of the V-line blemish, the V-line blemish is corrected. As a result, the V-line blemish according to a temperature change in the CCD can be corrected with high precision, so that a V-line blemish correction can be made possible while suppressing deterioration in picture quality.

The position information by temperature, indicating at least one position of a defect by temperature, is stored in the blemish information memory 54. According to at least one position of a defect corresponding to the temperature regarding the CCD detected by the temperature sensor 49, signal charges for detecting the level of the V-line blemish are read. With such a configuration, detection of the level of a V-line blemish according to a change in temperature can be performed at high speed.

Further, transfer of signal charges in the VCCD 162 is stopped only for a predetermined period (for example, 200 horizontal periods) in a state where an optical path extending from a subject to the image capturing sensor 16 is interrupted by the shutter mechanism and, after that, signal charges for level detection are read. With such a configuration, signal charges related to a defect can be read so as to be emphasized. Thus, detection of the level of a V-line blemish can be performed with high precision.

Second Preferred Embodiment

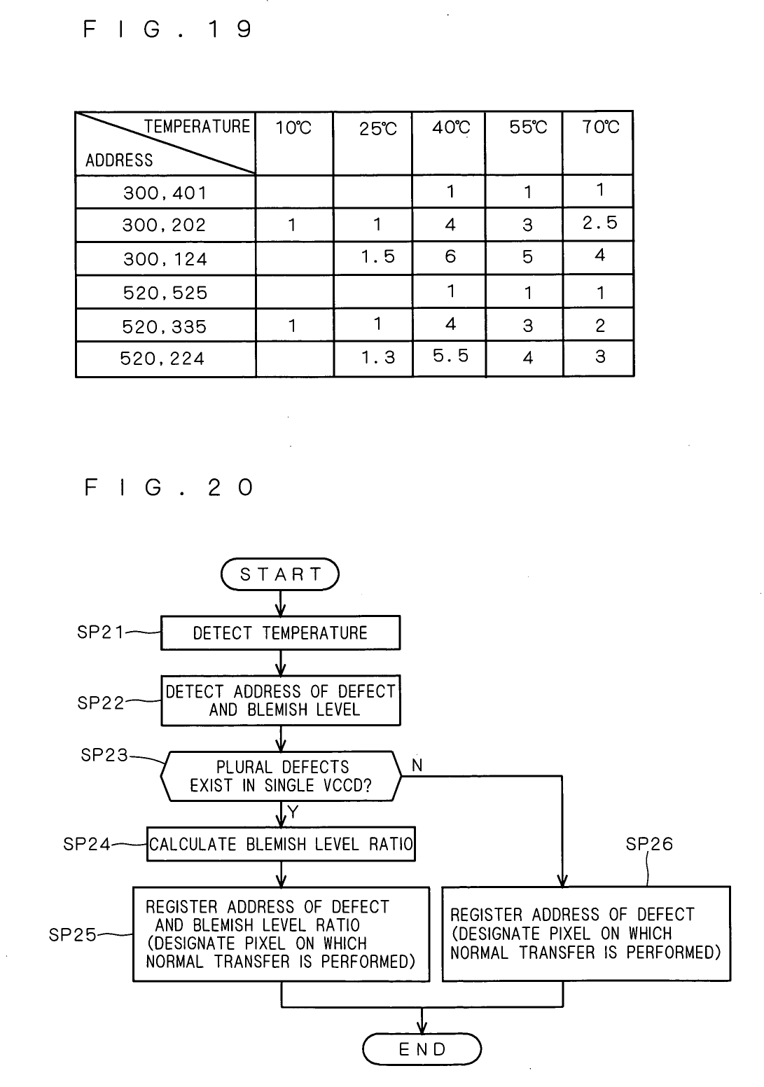

FIG. 17 is a diagram showing the configuration of the image capturing sensor 16 including a plurality of defects in a single VCCD 162.

In the case where a plurality of defective portions (blemishes) Fp1, Fp2, and Fp3 exist in a single VCCD 162 as shown in FIG. 17, first, in the defective portion Fp1, a charge C1 is added to a signal charge group Fa1 transferred from the upstream in a charge transfer direction Ha. In the defective portion Fp2, a charge C2 is added to a signal charge group Fa2 transferred from the upstream in the charge transfer direction Ha. Further, in the defective portion Fp3, a charge C3 is added to a signal charge group Fa3 transferred from the upstream in the charge transfer direction Ha. The resultant is reproduced as a line blemish (V-line blemish) Gb having high lightness in the captured image G2 as shown in FIG. 18.

In the captured image G2, a V-line blemish (that is, an area A1) whose level corresponds to the charge C1 occurs in an area corresponding to the interval between the defective portions Fp1 and Fp2. A V-line blemish (that is, an area A2) whose level corresponds to the charges (C1+C2) occurs in an area corresponding to the interval between the defective portions Fp2 and Fp3. Further, a V-line blemish (that is, an area A3) whose level corresponds to the charges (C1+C2+C3) occurs in an area corresponding to the upstream side of the defective portion Fp3.

In the case where the plurality of defective portions Fp1, Fp2, and Fp3 exist in one VCCD 162, although they construct one V-line blemish Gb corresponding to one VCCD 162, the levels in the areas A1 to A3 are different from each other, and the offset levels used for offset correction are not uniform. Therefore, a method of detecting the levels in the V-line blemish in the areas A1 to A3 and correcting the V-line blemish by using an offset may be employed.

However, when a method similar to that used in the image capturing apparatus 1 according to the first preferred embodiment is used to detect the level of the V-line blemish in each of the areas, long time is required to perform the normal transfer on signal charges in horizontal lines including the three defective portions Fp1, Fp2, and Fp3. That is, high-speed detection of the level of a V-line blemish is disturbed.

To detect the level of a V-line blemish at higher speed, in an image capturing apparatus 1A according to the second preferred embodiment, when a plurality of areas among which blemish levels are different from each other exist in a single V-line blemish, the ratio of numerical values of the blemish levels in the areas is preliminarily detected and stored in the blemish information memory 54. At the time of main image capturing, only the blemish level in one of the plurality of areas constructing one V-line blemish is detected, and the blemish levels in the other areas are calculated by using the blemish level ratio.

With respect to the blemish level ratio, for example, when the charges C1, C2, and C3 are detected as 20 mV, 60 mV, and 40 mV, respectively, if the blemish level in the area A1 on the most downstream side is used as a reference, the area A3 is influenced by the three defective portions Fp1, Fp2, and Fp3, so that the blemish level ratio in the area A3 becomes 6 (=120 mv/20 mV). The area A2 is influenced by the two defective portions Fp1 and Fp2, so that the blemish level ratio becomes 4 (=80 mV/20 mV). The area A1 is influenced by one defective portion Fp1, so that the blemish level ratio becomes 1 (=20 mV/20 mV).

The image capturing apparatus 1A according to the second preferred embodiment will be concretely described below. The image capturing apparatus 1A according to the second preferred embodiment is different from the image capturing apparatus 1 according to the first preferred embodiment only with respect to controls and computing methods in reading of signal charges and detection of the level of a V-line blemish at the time of detecting the level of a V-line blemish. Consequently, in the image capturing apparatus 1A, the same reference numerals are given to the same components as those of the image capturing apparatus 1 and their description is not repeated.

Blemish Level Ratio

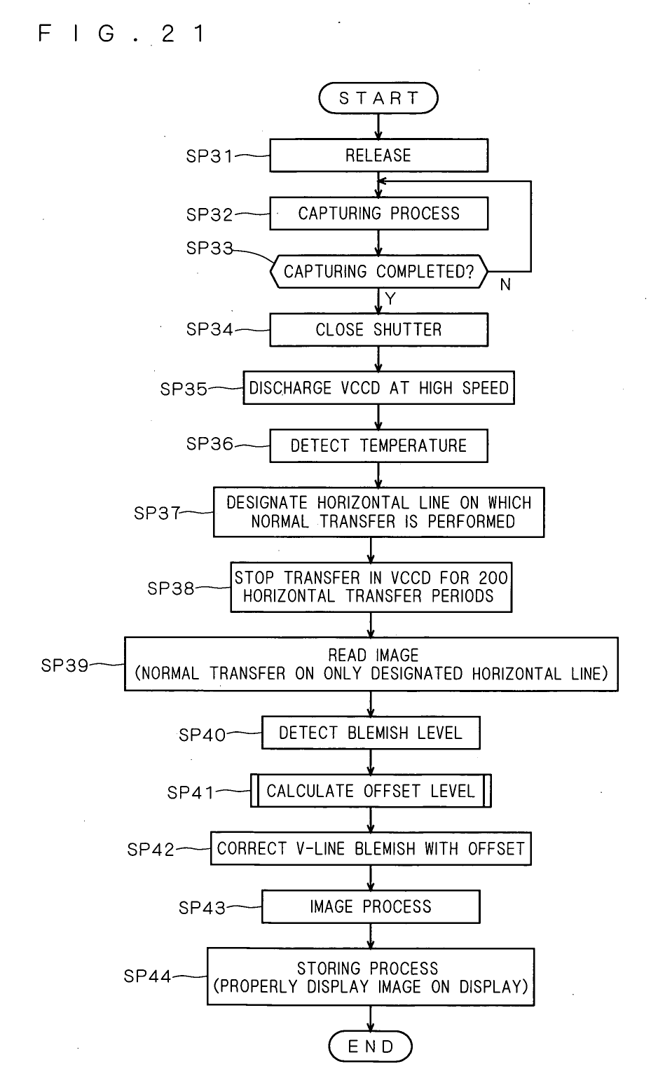

FIG. 19 is a diagram showing blemish level ratios to be stored in the blemish information memory 54.

As shown in FIG. 19, blemish level ratios are stored in the blemish information memory 54, as a table (also referred to as “blemish level ratio table” or “blemish-level-related information”) in which the blemish level ratios are associated with addresses of defective pixels by temperature of the CCD. Concretely, the blemish level ratio table in FIG. 19 shows the addresses of defective portions as causes of V-line blemishes and the V-line blemish level ratios corresponding to five temperatures of 10° C., 25° C., 40° C., 55° C., and 70° C. Although FIG. 19 shows the data only at the five temperatures in order to prevent the diagram from becoming complicated, in reality, the blemish level ratio table stores the addresses of defective portions and the blemish level ratios at temperatures in finer intervals.

The blemish level ratio is calculated by, for example, detecting the levels of V-line blemishes under a plurality of temperature conditions by a method similar to that in the image capturing apparatus 1 according to the first preferred embodiment before shipment of the image capturing apparatus 1A from a factory.

FIG. 20 is a flowchart showing an operation flow of calculating the blemish level ratios at temperatures and registering them into the blemish level ratio table. The operation flow is realized by the control of the camera controller 40.

In step SP21, the temperature regarding the image capturing sensor 16 is detected by the temperature sensor 49.

In step SP22, the address and a blemish level of a defective portion are detected. In this case, an amount of charges generated in the defective portion is increased by stopping transfer of the VCCD 162 for a predetermined period and, after that, an image is read. In such a manner, an image in which pixel data in the photodiode Dp from which a signal charge is read via the defective portion on the VCCD 162 is emphasized can be output from the image capturing sensor 16. By detecting the address of a pixel as a luminance point of high lightness in the read image, the position (address) of the defective portion corresponding to the lower end of each of the areas in which the levels of the V-line blemish are different from each other can be detected. The level of the V-line blemish can be detected on the basis of a level obtained by normalization of reducing the emphasized signal charge to 1/200.

In step SP23, whether there are a plurality of defects in a single VCCD 162 or not is determined. If YES, the program advances to step SP24. If NO, the program advances to step SP26.

In step SP24, the blemish level ratio is calculated on the basis of the blemish level detected in step SP22. In this case, the blemish level ratio is calculated by using, as a reference, the blemish level corresponding to a defect on the most downstream side among a plurality of defects existing in one VCCD 162.

In step SP25, the address and the blemish level ratio of a defect are stored so as to be associated with each other in the blemish level ratio table. With respect to the VCCD 162 having a plurality of defects, the position indicative of the defective portion on the most downstream side among the plurality of defects is designated as the position of a pixel on which the normal transfer is performed (normal transfer address). On the other hand, with respect to the VCCD 162 having only one defect, the position of the one defective portion is designated as the normal transfer address. Although not shown, the normal transfer address is also stored in the blemish information memory 54. FIG. 19 shows that an address to which “1” is given as the blemish level ratio is the normal transfer address.

In step SP26, the address of the defective portion detected in step SP22 is stored in the blemish information memory 54. At this time, the positions of all of defective portions are designated as the normal transfer addresses, and the normal transfer addresses are stored in the blemish information memory 54.

By performing such an operation at temperatures such as 10° C., 25° C., 40° C., 55° C., and 70° C., a blemish level ratio table as shown in FIG. 19 can be generated.

Image Capturing Operation

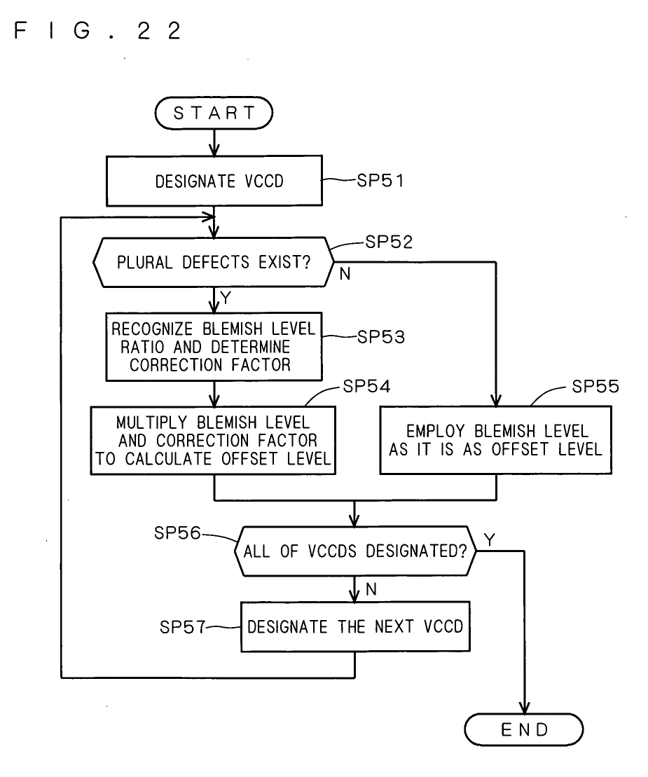

FIGS. 21 and 22 are flowcharts showing the image capturing operation flow in the image capturing apparatus 1A. The operation flow is realized by control of the camera controller 40.

In steps SP31 to SP36, processes similar to those in steps S1 to SP6 in FIG. 16 are performed.

In step SP37, by referring to the normal transfer addresses stored in the blemish information memory 54, a horizontal line whose signal charges are subjected to the normal transfer is recognized according to the temperature detected in step SP36 and is designated.

In step SP38, a process similar to that in step SP8 in FIG. 16 is performed.

In step SP39, as described above, reading of image data is executed in such a manner that while the normal transfer is performed only on the signal charges in the horizontal line designated in step SP37, the high-speed transfer is performed on the signal charges in the other horizontal lines. With respect to the VCCD 162 having a plurality of defective portions, the normal transfer is performed on signal charges corresponding to the normal transfer addresses out of the plurality of defective portions. On the other hand, the signal charges corresponding to the other defective portions are transferred at high speed and discharged. For example, as shown in FIG. 17, when the plurality of defective portions Fp1, Fp2, and Fp3 exist in one VCCD 162, the signal charge corresponding to the defective portion Fp1 is subjected to the normal transfer.

In step S40, the V-line blemish detector 52 detects the level of the V-line blemish on the basis of the image data read in step SP39. With respect to the VCCD 162 having a plurality of defective portions, the level of a V-line blemish which occurs in an image due to one defective portion corresponding to the normal transfer address in the plurality of defective portions is detected.

In step S41, an offset amount (level) according to the level of the V-line blemish detected in step SP40 is calculated. Concretely, the operation flow shown in FIG. 22 is executed.

In step SP51, one VCCD 162 in the image capturing sensor 16 is designated.

In step S52, whether the VCCD 162 designated in step SP51 or step SP57 which will be described later has a plurality of defects or not is determined. If YES, the program advances to step SP53. If NO, the program advances to step SP55.

In step SP53, with reference to the blemish level ratio table stored in the blemish information memory 54, the blemish level ratio corresponding to the temperature detected in step SP36 is recognized and determined as a correction factor.

In step SP54, by multiplying the blemish level directly detected in step SP40 and the correction factor determined in step SP53 for each defective portion, each blemish level is detected and calculated as an offset level.

In step SP55, the blemish level detected in step SP40 is employed as it is as an offset level.

In step SP56, whether all of the VCCDs 162 arranged in the image capturing sensor 16 have been designated or not is determined. The next VCCD 162 is designated (step SP57) until all of the VCCDs 162 are designated and the program returns to step SP52. When all of the VCCDs 162 are designated, the operation flow shown in FIG. 22 is finished, and the program advances to step SP42.

In steps SP42 to SP44, processes similar to those in steps SP12 to SP14 in FIG. 16 are performed.

As described above, in the image capturing apparatus 1A according to the second preferred embodiment of the present invention, in the case where three (generally, a plurality of) defects Fp1 to Fp3 including the defects Fp1 and Fp2 exist in the same VCCD 162, the ratio of levels of V-line blemishes (blemish level ratio) which occur in an image due to the plurality of defects is stored in the blemish information memory 54. In such a state, at the time of main image capturing, the normal transfer is performed on the signal charge corresponding to the position of the defect Fp1 out of the signal charges corresponding to all of pixels in the CCD. On the other hand, the signal charges corresponding to the positions of the defects Fp2 and Fp3 are transferred at high speed and discharged, thereby reading signal charges for detecting the level of the V-line blemish. The level of the V-line blemish related to the defect Fp1 is detected on the basis of the signal charges for level detection. The level of the V-line blemish which occurs due to both of the defects Fp1 and Fp2 and the level of the V-line blemish which occurs due to all of the defects Fp1 to Fp3 are detected by computation using the blemish level ratios. As a result, the level of the V-line blemish can be detected at higher speed.

Information indicative of the V-line blemish level ratio by temperature is stored in the blemish information memory 54. On the basis of the blemish level ratio corresponding to the temperature regarding the CCD, the level of a V-line blemish which occurs due to both of the defects Fp1 and Fp2 and the level of a V-line blemish which occurs due to all of the defects Fp1 to Fp3 are detected by computation. With such a configuration, detection of the level of a V-line blemish according to a change in temperature can be performed at high speed.

Modifications

Although the preferred embodiments of the present invention have been described above, the present invention is not limited to the above.

For example, although a so-called interline-transfer-type CCD is used as the CCD image capturing device in the foregoing preferred embodiments, the present invention is not limited to the CCD. For example, other CCDs such as a so-called frame-transfer-type CCD may be also employed.

Although the position and the blemish level of a defect in a charge transfer line which is a cause of a V-line blemish are detected before factory shipment in the foregoing preferred embodiment, the present invention is not limited to the preferred embodiments. For example, they may be detected at the time of turning off the power of the image capturing apparatus 1 or 1A to update the position and the blemish level of the defect in the charge transfer line.

Although the level of a V-line blemish is detected immediately after main image capturing in the foregoing preferred embodiments, the present invention is not limited to the preferred embodiments. Also in the case where the level of a V-line blemish is detected immediately before main image capturing, effects similar to those of the foregoing preferred embodiments can be obtained.

Although the case where three defects caused by occurrence of a V-line blemish exist in a single VCCD 162 has been described in the second preferred embodiment, the present invention is not limited to the case. In the case where a plurality of defects as a cause of a V-line blemish exist in a single VCCD 162, effects similar to those of the second preferred embodiment can be obtained by a method similar to the second preferred embodiment.

In the second preferred embodiment, in the case where a plurality of defects exist in a single VCCD 162, the blemish level ratio in areas where the levels of a V-line blemish are different from each other is stored in the blemish information memory 54 before factory shipment. At the time of main image capturing, only the level of one defect is detected and the blemish levels in a plurality of areas constructing a single V-line blemish are calculated by using the blemish level ratio. The present invention however is not limited to the preferred embodiment. For example, the ratio of levels of V-line blemishes which occur due to each of the defects is stored as the blemish level ratio in the blemish information memory 54 before factory shipment or the like. At the time of main image capturing, the blemish level of one of the plurality of defects is detected. First, the levels of blemish which occur due to each of the defects are calculated by using the blemish level ratio. The blemish levels are added so that the blemish level becomes higher toward the upstream side of the VCCD 162, thereby calculating (detecting) the blemish levels of the plurality of areas constructing a single V-line blemish.

Concretely, when it is assumed that, as shown in FIGS. 17 and 18, a single VCCD 162 has a plurality of defective portions Fp1, Fp2, and Fp3 and the ratio of levels (blemish level ratio) of a blemish caused by the defective portions Fp1, Fp2, and Fp3 is 1:3:2, the blemish level ratio is computed before factory shipment and stored in the blemish information memory 54. At the time of main image capturing, if the level of a blemish which occurs due to any one of the defective portions Fp1, Fp2, and Fp3 is detected, the level of a defect which occurs due to another defective portion is determined. For example, when the blemish level related to the defective portion Fpl is detected as 20 mV, the blemish level related to the defective portion Fp2 is detected as 60 mV, and the blemish level related to the defective portion Fp3 is detected as 40 mV. Since the signal charges transferred in the VCCD 162 are influenced by all of defective portions through which the signal charges pass, the blemish level related to the area A1 corresponding to the interval between the defective portions Fp1 and Fp2 can be calculated as 20 mV. The blemish level related to the area A2 corresponding to the interval between the defective portions Fp2 and Fp3 can be calculated as 80 mV (20 mV+60 mV). The blemish level related to the area A3 corresponding to the upstream side of the defective portion Fp3 can be calculated as 120 mV (=20 mV+60 mV+40 mV).

Also with such a configuration, effects similar to those of the second preferred embodiment can be obtained.

Although a CCD of a type in which all of pixels are read is used in the foregoing preferred embodiments, the present invention is not limited to the CCD. For example, a CCD of a type in which a plurality of fields are read may be used. Since defect information in this case is transfer line information, it is sufficient to make the same correction in all of the fields.

In detection of a V-line blemish, a pixel signal is not shifted to a transfer line. Consequently, the detection is performed in the same way in the CCD of the all-pixel-reading type and the CCD of the plural-field-reading type.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image capturing part which has a CCD including a charge transfer line and captures an image of a subject;
a storing part which stores position information of a defect in said charge transfer line, which causes a line blemish in said image of a subject;
a reading part which reads signal charges for detecting a level of said line blemish by performing a normal transfer on signal charges corresponding to a position of said defect in signal charges corresponding to all of the pixels in said CCD and performing a high-speed transfer on signal charges which do not correspond to said position of said defect in said charge transfer line; and
a correcting part which corrects said line blemish on the basis of said signal charges for detecting a level of said line blemish read by said reading part.

2. The image capturing apparatus according to claim 1, further comprising:
a blemish level detecting part which detects a level of said line blemish on the basis of said signal charges for detecting a level of said line blemish, wherein said correcting part corrects said line blemish in accordance with a result of detection performed by said blemish level detecting part.

3. The image capturing apparatus according to claim 2, wherein
said correcting part corrects said line blemish by an offset using said level of said line blemish detected by said blemish level detecting part.

4. The image capturing apparatus according to claim 2, wherein
said storing part stores position information by temperature, indicative of position of said defect by temperature,
said image capturing apparatus further comprises:
a temperature detecting part which detects temperature regarding said CCD; and
a position recognizing part which recognizes a position of said defect corresponding to a temperature detected by said temperature detecting part with reference to said position information by temperature, and
said reading part reads said signal charges for detecting a level of said line blemish in accordance with said position of said defect recognized by said position recognizing part.

5. The image capturing apparatus according to claim 2, wherein
when at least first and second defects as causes of said line blemish in said image of a subject exist on a charge transfer line, said storing part stores at least position information of said first and second defects, and stores level relation information indicative of a numerical relation between a level of a first line blemish which occurs in said image of a subject due to said first defect and a level of a second line blemish which occurs in said image of a subject due to at least both of said first and second defects,
said reading part reads said signal charges for detecting a level of said line blemish by performing said normal transfer on signal charges corresponding to a position of said first defect in signal charges corresponding to all of the pixels in said CCD and performing said high-speed transfer on signal charges corresponding to a position of said second defect in said charge transfer line, and
said blemish level detecting part has:
a first level detecting part which detects said level of a first line blemish on the basis of said signal charges for detecting a level of said line blemish; and
a second level detecting part which detects said level of a second line blemish on the basis of said level of a first line blemish detected by said first level detecting part and said level relation information.

6. The image capturing apparatus according to claim 5, wherein
said storing part stores a level relation information by temperature, indicative of said numerical relation by temperature,
said image capturing apparatus further comprises:
a temperature detecting part which detects temperature regarding said CCD; and
a numerical relation recognizing part which recognizes a numerical relation corresponding to a temperature detected by said temperature detecting part with reference to said level relation information by temperature, and
said second level detecting part detects said level of a second line blemish on the basis of said numerical relation recognized by said numerical relation recognizing part.

7. The image capturing apparatus according to claim 2, wherein
when at least first and second defects as causes of said line blemish in said image of a subject exist on a charge transfer line, said storing part stores at least position information of said first and second defects, and stores level relation information indicative of a numerical relation between a level of a first line blemish which occurs in said image of a subject due to said first defect and a level of a second line blemish which occurs in said image of a subject due to said second defect,
said reading part reads said signal charges for detecting a level of said line blemish by performing said normal transfer on signal charges corresponding to a position of said first defect in signal charges corresponding to all of the pixels in said CCD and performing said high-speed transfer on signal charges corresponding to a position of said second defect in said charge transfer line, and
said blemish level detecting part has:
a first level detecting part which detects said level of a first line blemish on the basis of said signal charges for detecting a level of said line blemish; and
a third level detecting part which detects a level of a third line blemish occurring in said image of a subject due to at least both of said first and second defects on the basis of said level of a first line blemish detected by said first level detecting part and said level relation information.

8. The image capturing apparatus according to claim 7, wherein
said storing part stores a level relation information by temperature, indicative of said numerical relation by temperature,
said image capturing apparatus further comprises:
a temperature detecting part which detects temperature regarding said CCD; and
a numerical relation recognizing part which recognizes a numerical relation corresponding to a temperature detected by said temperature detecting part with reference to said level relation information by temperature, and
said second level detecting part detects said level of a third line blemish on the basis of said numerical relation recognized by said numerical relation recognizing part.

9. The image capturing apparatus according to claim 1, wherein
after transfer of signal charges in said charge transfer line is stopped only for a predetermined period in a state where an optical path extending from said subject to said image capturing part is interrupted by a predetermined shutter mechanism, said reading part reads said signal charges for detecting a level of said line blemish.

10. A method of capturing an image in an image capturing apparatus comprising an image capturing part having a CCD including a charge transfer line and capturing an image of a subject, the method comprising the steps of:
(a) storing position information of a defect in said charge transfer line, which causes a line blemish in said image;
(b) reading signal charges for detecting a level of said line blemish by performing a normal transfer on signal charges corresponding to a position of said defect in signal charges corresponding to all of the pixels in said CCD and performing a high-speed transfer on signal charges which do not correspond to said position of said defect in said charge transfer line; and
(c) correcting said line blemish on the basis of said signal charges for detecting a level of said line blemish read in said step (b).
